(19) United States
(12) Patent Application Publication
(10) Pub. No.: US 2012/0304192 A1
(43) Pub. Date: Nov. 29, 2012

(54) LIFELINE-BASED GLOBAL LOAD BALANCING

(75) Inventors: David Paul Grove, Ridgefield, CT (US); Prabhanjan Kambadur, New York, NY (US); Sreedhar Babu Kodali, Konena Agrahara (IN); Vijay Anand Saraswat, Mahopac, NY (US)

(73) Assignee: INTERNATIONAL BUSINESS MACHINES, Armonk, NY (US)

(21) Appl. No.: 13/479,940

(22) Filed: May 24, 2012

Related U.S. Application Data
(60) Provisional application No. 61/490,663, filed on May 27, 2011.

(51) Int. Cl. G06F 9/46

(52) U.S. Cl. 718/105

(57) ABSTRACT

Work-stealing is efficiently extended to distributed memory using low degree, low-diameter, fully-connected directed lifeline graphs. These lifeline graphs include k-dimensional hypercubes. When a node is unable to find work after w unsuccessful steals, that node quiesces after informing the outgoing edges in its lifeline graph. Quiescent nodes do not disturb other nodes. Each quiesced node reactivates when work arrives from a lifeline, itself sharing this work with its incoming lifelines that are activated. Termination occurs when computation at all nodes has quiesced. In a language such as X10, such passive distributed termination is detected automatically using the finish construct.

### CROSS REFERENCE TO RELATED APPLICATIONS

The present invention claims priority to U.S. Provisional Patent Application No. 61/490,663, filed May 27, 2011. The entire disclosure of that application is incorporated herein by reference.

### STATEMENT REGARDING FEDERALLY SPONSORED RESEARCH

The invention disclosed herein was made with U.S. Government support under Contract No. HR0011-07-9-0002 awarded by (DARPA) Defense Advanced Research Projects Agency. The Government has certain rights in this invention.

### FIELD OF THE INVENTION

The present invention relates to load balancing in distributed memory.

### BACKGROUND OF THE INVENTION

Load balancing among processors or cores is used to improve the performance of parallel or multi-threaded programs. One challenge is the division of units of work to balance the computational load among the plurality of processors or cores. One method for dividing or sharing work to accomplish instantaneous load balancing is work stealing. In work stealing, one processor that lacks a sufficient amount of work takes or steals work, i.e., computational tasks, from another processor that has extra work. Both of these processors are located within a given shared memory system. In shared memory systems, Cilk-style, which is a C-based runtime system for multi-threaded parallel programming, work-stealing has been used to effectively parallelize irregular task-graph based applications such as Unbalanced Tree Search (UTS).

Two main difficulties exist in extending work-stealing from a shared memory system to distributed memory. In the shared memory approach, thieves, i.e., nodes without work, constantly attempt to asynchronously steal work from randomly chosen victims until they find work. In distributed memory, thieves cannot autonomously steal work from a victim without disrupting the execution of application threads on that victim. When work is sparse, execution disruption results in performance degradation. Direct extension of traditional work-stealing to distributed memory, however, violates the work-first principle underlying work-stealing. In addition, thieves spend useless central processing unit (CPU) cycles attacking victims that have no work, resulting in system inefficiencies in multiprogrammed contexts. Second, it is non-trivial to detect active distributed termination, i.e., to detect that programs at all nodes in a distributed system are looking for work and no work is available. Termination detection requires a carefully arranged implementation to yield good performance. Unfortunately, in most existing languages and frameworks, application developers are forced to implement their own distributed termination detection.

### SUMMARY OF THE INVENTION

Exemplary embodiments of systems and methods in accordance with the present invention efficiently extend work-stealing to distributed memory. As used herein, distributed memory refers to computing system containing a plurality of processors. Each includes an associated memory. In order to share data or tasks, each processor communicates with one or more remote processors. In shared memory, a single memory space is used by all processors. The present invention utilitzes lifeline graphs, which are low-degree, low-diameter, fully-connected directed graphs. In one embodiment, suitable lifeline graphs are constructed from k-dimensional hypercubes. When a node is unable to find work after a given number of unsuccessful steals, that node quiesces after informing the outgoing edges in its lifeline graph. Quiescent nodes do not disturb other nodes. A quiesced node is reactivated when work arrives from a lifeline, and that reactivated node shares this work with its incoming lifelines that are activated. Termination occurs when computation at all nodes has quiesced. In a suitable parallel programming language, e.g., X10, passive distributed termination is detected automatically using the finish construct, i.e., no application code is required.

Exemplary embodiments of systems and methods in accordance with the present invention, are implemented in a few hundred lines of X10. On the binomial tree the program achieves about 87% efficiency on an Infiniband cluster of 1024 Power7 cores, with a peak throughput of about 2.37 GNodes/sec. In addition, the program achieves about 87% efficiency on a Blue Gene/P with 2048 processors, and a peak throughput of about 0.966 GNodes/s. All numbers are relative to single core sequential performance. This implementation has been refactored into a reusable global load balancing framework. Applications use this framework to obtain global load balance with minimal code changes.

In one embodiment, the present invention includes the first formulation of UTS that does not involve application level global termination detection, the introduction of lifeline graphs to reduce failed steals, the demonstration of simple lifeline graphs based on k-dimensional hypercubes, and performance with superior efficiency, or the same efficiency but over a wider range, than published results on UTS. In one embodiment, the framework in accordance with the present invention delivers the same or better performance as an unrestricted random work-stealing implementation, while reducing the number of attempted steals. In one embodiment, global work stealing is elegantly formulated as a simple X10 program using async, at and finish.

Initially, one async is launched at every place, under the control of a single finish. The termination of this finish signals global termination. These asyncs initially attempt to look for work by guessing a random id and looking for work at the place with that id. This can be done using the at operator, without spawning any new asyncs. In “pure” work-stealing, if the async did not find any work at this victim, it continues looking for work at other victims. This leads immediately to the active termination detection problem (when should the async know to stop looking for work, because there is no work?) Exemplary embodiments of systems and methods in accordance with the present invention perform such random steals no more than a definite maximum number of times, w If no work has been found after w attempts, the async terminates. However, before termination, the async establishes one or more lifelines. A lifeline is another place or node within the distributed memory system. Establishing a lifeline includes checking if that place has work. If that other place has work, a steal is performed as usual. If that other place does not have work then the id of the thief is recorded at that place as an “incoming” lifeline. Since that place does not have any work, that place recursively establishes a lifeline. Once a given place finds some work, that place checks to see if any incoming lifelines have been recorded. If so, a portion of its work is distributed to this lifeline q, and that lifeline is cleared. Distribution is performed by spawning an async at place q, which re-initiates activity at q. When all the asyncs in the system have terminated, this is an indication that there is no more work left to do, and this condition is detected by the single top-level finish.

In accordance with one exemplary embodiment, the present invention is directed to a method for load balancing in a distributed memory system. A lifeline graph is established within the distributed memory system. This lifeline graph includes a plurality of vertices, and each vertex represents a node within the distributed memory system configured to execute tasks. In addition, the lifeline graph includes a plurality of edges. Each edge extends between a given pair of vertices such that each vertex has associated incoming edges for receiving tasks from other vertices and outgoing edges for transferring tasks to other vertices. Overall, the plurality of edges is arrange among the vertices such that a path exists through the lifeline graph from any given vertex to every other vertex. In one embodiment, the lifeline graph is established as a cyclic hypercube lifeline graph.

In one embodiment, the lifeline graph is established by performing a pre-determined finite number of attempts to obtain tasks at each one of a plurality of acquiring nodes from a set of randomly selected target nodes within the distributed memory system and establishing edges from each acquiring node to one or more target nodes in its set of randomly selected target nodes when all attempts to obtain tasks are unsuccessful. This includes recording an identification of a given acquiring node in combination with an established edge at a given target node when that given target node does not contain tasks capable of being obtained by the given acquiring node. The established edge and the given acquiring node identification represent an incoming edge at the given target node. In one embodiment, edges are established from each acquiring node to a pre-determined bounded number of target nodes.

In one embodiment, an asynchronous activity platform from a parallel processing program running on the distributed memory system is instantiated at each acquiring node to support performing the pre-determined finite number of attempts to obtain tasks from each target node and establishing vertices from each acquiring node to one or more target nodes. The asynchronous activity platform instance at each acquiring node is terminated following establishment of the edges from that acquiring node to the target nodes.

With the lifeline graph established, work is received at given node within the lifeline graph. This work includes a plurality of tasks. A portion of the plurality of tasks is distributed along each incoming edge associated with that node to a receiving node for which that incoming edge comprises an outgoing edge. In addition, a subset of any given portion of the plurality of tasks received at any receiving node is distributed along each incoming node associated with that receiving node to a subsequent receiving node for which that receiving node incoming edge comprises an outgoing edge. This distribution of subsets of tasks between vertices is continued until all tasks have been distributed through the vertices in the lifeline graph.

In one embodiment, a place shifting operation from a parallel processing program running on the distributed memory system is used to move the portion of the plurality of tasks along each incoming edge. In addition, an asynchronous activity platform from the parallel processing program is instantiated at each receiving node to support execution of tasks distributed to that receiving node. The system is monitored for termination of all asynchronous activity platform instances using a single top-level termination monitoring utility from the parallel processing program. Termination of all asynchronous activity platform instances indicates completion of all tasks within the distributed memory system. In one embodiment, each incoming edge associated with the given node is removed from the lifeline graph following distribution of the portion of the plurality of tasks to the receiving node.

In one exemplary embodiment, the present invention is directed to a method for load balancing in a distributed memory system where an asynchronous activity platform from a parallel processing program running on the distributed memory system is instantiated at each one of a plurality of nodes within the distributed memory system. Each node is configured to execute tasks. An instance of the asynchronous activity platform is used at each one of a plurality of acquiring nodes to support performing a pre-determined finite number of attempts to obtain tasks for each acquiring node from one or more randomly selected target nodes. Edges are established from each acquiring node to one or more target nodes in its set of randomly selected target nodes when all attempts to obtain tasks are unsuccessful. These edges are incoming edges at the acquiring nodes for receiving tasks from the target nodes and outgoing edges at the target nodes for transferring tasks to the acquiring nodes. Work containing a plurality of tasks is received at given node. A place shifting operation from the parallel processing program distributes a portion of the plurality of tasks along each incoming edge associated with that node to a receiving acquiring node for which that incoming edge comprises an outgoing edge. In addition, instances of the asynchronous activity platform at each receiving acquiring node support execution of tasks distributed to that receiving acquiring node. Termination of all asynchronous activity platform instances is monitored using a single top-level termination monitoring utility from the parallel processing program, wherein termination of all asynchronous activity platform instances indicates distribution and completion of all tasks within the distributed memory system.

### BRIEF DESCRIPTION OF THE DRAWINGS

FIG. 1 is a graph illustrating processing speedup versus the number of processors for an embodiment of given arrangements of processing platform, work stealing attempts and lifeline creation;

FIG. 2 is a graph illustrating processing speedup versus the number of processors for another embodiment of given arrangements of processing platform, work stealing attempts and lifeline creation;

FIG. 3 is a graph illustrating processing speedup versus the number of processors for another embodiment of given arrangements of processing platform, work stealing attempts and lifeline creation;

FIG. 4 is a graph illustrating processing speedup versus the number of processors for another embodiment of given arrangements of processing platform, work stealing attempts and lifeline creation;

FIG. 5 is a graph illustrating processing speedup versus the number of processors for another embodiment of given arrangements of processing platform, work stealing attempts and lifeline creation;

FIG. 6 is a graph illustrating processing speedup versus the number of processors for another embodiment of given arrangements of processing platform, work stealing attempts and lifeline creation; and

FIG. 7 is a flow chart illustrating an embodiment of a method load balancing in a distributed memory system in accordance with the present invention.

### DETAILED DESCRIPTION

The emergence of new architectures that emphasize distributed memory, e.g., clouds and commodity clusters, P71H, and BlueGene, provides significant new opportunities for application developers. New application areas such as business analytics and data mining are presented with unparalleled opportunities to deal efficiently with large workloads. However, these exciting opportunities bring new challenges for parallel system designers. The Asynchronous Partitioned Global Address Space (APGAS) programming model provides a useful and convenient framework for stating these problems and their solutions. The parallel processing system is viewed as a collection of places, e.g., nodes, processors or cores, for example in a distributed memory system. Data is partitioned across the places with support for selective replication. In addition to remote data access through one-sided communication primitives, activities, i.e., work, jobs or tasks, can be launched on remote places. This allows complementary approaches to move the data or the computation as they match the application domain, e.g., linear algebra vs. tree traversal. The APGAS framework also subsumes other newer programming models such as Map-Reduce. Map-Reduce frameworks such as Hadoop allow parallel processing of large files using user-defined map and reduce operations. However, it is challenging to rewrite well-established parallel algorithms to fit the map-reduce model.

Global load balancing presents a challenge to achieving the promise of scale-out computing in such a programming model. Many problems can be conceptualized in terms of distributed task collections, with dependences between them expressed as data or control dependences. In accordance with the present invention, task collections with no dependences are used. The tasks encapsulate all data needed for their processing and do not take advantage of the global address space. Dynamically load balancing such a computation assumes these tasks to be mobile, i.e, they can be executed anywhere and do not exhibit affinity to a place. Exemplary embodiments in accordance with the present invention provide a solution to global load balancing for such a collection of tasks.

In the context of shared-memory systems, tasks to be processed at each place are held in a deque. The worker or processor at a given place processes tasks from the top, and acquiring places or nodes take tasks from the bottom of the deque. Each worker continues to processes its local tasks until that worker runs out of work. Acquiring nodes attempt to minimize their idle time by looking for work to acquire from other target nodes. If T₁ is the time to run a program with one worker and T_{∞} is the time required to run the same program with an infinite number of workers, then T_{P}, the time to run this program with P workers is T₁/P+T_{∞}. Simultaneously, the space required to run a program with P workers is bounded by P×S(1), where S(1) is the space required to run the program with one worker. This approach is usually referred to as “work-stealing”.

Although work-stealing appears simple at the outset and has attractive space and time bounds, efficient parallelization of applications using the work-stealing scheduler requires careful engineering. A factor in getting optimal performance in a work-stealing scheduler is reducing the critical path overhead. A worker busy with work continues with that work and is not interrupted to help an acquiring node. Implementations, such as Cilk's “THE” protocol have been carefully constructed so that a worker thread does not pay more than the cost of a volatile write in all those cases where it is not a target node. In fact, the THE protocol also ensures that targets do not pay the cost of locking and unlocking the deque unless there is a single task for which to be wrestled. However, if the worker is an acquirer, it has to acquire a lock before stealing a task from the target node. In this scheduling scheme, contention arises when multiple acquiring nodes try to steal from the same target node, there is a single task on the target node's deque, or both.

In a distributed memory setting, local and remote data accesses incur different costs, and the cost of communication cannot be ignored. In addition, different communication operations can incur very different costs, e.g., lock operations vs. data access. While lock contention can be expensive in shared memory machines, it has been shown to dramatically impact parallel efficiency at scale in distributed memory contexts. On many architectures, the operations involved in stealing work are not supported in hardware. As a result, steals interrupt the remote worker, incurring additional cost. In particular, the time to process a given set of tasks depends not just on the tasks being processed, but also on the number interruptions due to incoming steal requests. Another issue is termination detection. In the usual formulation, computation terminates once every worker is looking for work. At this point, no worker has work. In the shared memory case, termination detection is implemented with a simple barrier algorithm. When a given worker finishes its work, it checks into the barrier. If it finds it is the last worker to check into the barrier, it signals termination to all other workers. Otherwise that worker looks for work randomly, periodically checking to see if termination has been signaled and terminating itself if termination has been signaled. If that worker finds work, it checks out of the barrier before claiming the work, guaranteeing correctness.

As the number of workers scales, repeatedly checking into and out of the barrier causes performance problems, and more scalable algorithms are needed. One solution proposes that workers enter the barrier only when they are “nearly certain” that there is no work in the system. This heuristic decision is made as follows. The worker randomly selects a target. If the target has no work, the acquirer moves to the next worker. Once it completes a circuit of all workers it makes the decision that there is likely no work in the system and enters the barrier. These additional traversals are of size O(P) and can increase the latency to termination.

On scale out, the single location becomes a bottleneck. Instead a combining tree is needed. A node forwards a termination signal only when it has processed all its work. The algorithm involves phases of signaling up and down the tree. In the up phase, each node signals its parent for successful termination only if such a decision is reported by this node and its children. In the down phase, each node forwards the signal to its children and exit task processing if a terminate signal was received. The root of the tree broadcasts a terminate signal through its children only if its children and itself voted for termination. When a target of a steal since the last vote becomes idle, it votes not to terminate. Thus termination is successfully detected by the root node only when all nodes participate in the up phase with no steals since the last up phase. This results in multiple termination detection phases during the computation, which is also slowed down due to active stealing by the nodes.

X10 is a programming language or parallel processing program that uses PGAS. The X10 parallel processing program facilitates the dividing of an application such as a multi-threaded application for concurrent parallel execution on a plurality of places or node, e.g., physical or logical cores. Each place can store data and host activities, e.g., tasks. In X10, any activity may spawn (“push”) more activities on any node in the system. X10 uses a place shifting operation at to move any given task or part of a task between places. In addition, instances of an asynchronous activity platform async are used on each place or node to provide functions such as the search for tasks at targets and the execution of tasks. A single termination monitoring utility finish monitors all instances of async and detects when all activities spawned within its scope have terminated including the execution of tasks and the search for task to acquire at targets.

In contrast with the active version of the problem, worker threads at each place are passive, they wait for the arrival of messages containing work rather than actively searching for work themselves. X10 implements a particular version of vector counts to detect passive termination. Each worker maintains a vector of counts, one per place. This vector tracks how many asyncs this place has created remotely, and how many asyncs have terminated at this place. Once a place has quiesced, i.e., there is no activity running at that place, it sends its vector to the place that spawned the finish. This place simply sum-reduces the count (component-wise). Termination is detected once, and only once, the reduced vector is zero. For computations in which a place spawns computations at only a few other places, say bounded by a constant z, only vectors of size z need to be communicated between places. These arrangements do not involve speculative waves of termination detection, rather they simply monotonically accumulate a set of vector counts, until the set reduces to zero.

When attempting to solve the UTS problem in X10 the natural question is whether finish can be used to implement UTS termination detection. Exemplary embodiments in accordance with the present invention successfully use finish to implement termination detection. In one embodiment, global work stealing is implemented as a simple X10 program using async, at and finish.

Exemplary embodiments in accordance with the present invention establish a lifeline graph within the distributed memory system. This lifeline graph includes a plurality of vertices. Each vertex is a node or place within the distributed memory system that executes tasks. In addition, the graph includes a plurality of edges. Each edge extends between a given pair of vertices such that each vertex or node has associated incoming edges for receiving tasks from other vertices, i.e., targets, and outgoing edges for transferring tasks to other vertices, i.e., acquirers. The plurality of edges is arranged among the vertices such that a path exists through the lifeline graph from any given vertex to every other vertex. These vertices between nodes are referred to as lifelines.

In selecting a lifeline for a given node, another node can be chosen at random. For example, place p may randomly choose to make q its lifeline, and simultaneously q could choose to make p its lifeline. As a result both places will be dead, both will not have any running activity and will never get one. Hence throughput and scalability will suffer. Therefore, randomly choosing lifelines is not an adequate solution. A good lifeline graph has the property that as long as there is a place that has work, there is a path from that place to every other place in the distributed memory system. An alternative is to base the lifeline graph on a permutation with cycle of length P. For instance, each place p can be mapped to place (p+1)% P. This guarantees that the only cycle is of length P. Therefore, a given place is involved in a cycle only if all places are involved in it, i.e., only when there is no work. This scheme is correct and works reasonably well for small P. However, it takes on the average P/2 hops for work to reach a second place from a first place. During this time the target, i.e., second, place is idle.

In another embodiment, a fully connected lifeline graph is used, having an edge from every vertex to every other vertex. While this ensures that tasks have to take only one hop to reach an idle worker, tasks at one site have to be divided up into many pieces, one for each incoming lifeline. Workers with tasks on their hands may waste cycles moving tasks to their numerous incoming lifelines, instead of executing them.

Systems and methods in accordance with the present invention utilize directed graphs where each vertex, i.e., node, has a bounded out-degree. In addition, the graph is connected and has a low diameter, i.e., there are short paths from every vertex to every other vertex. Suitable directed graphs include cyclic hypercubes. In a cyclic hypercube, a radix h and a power z are chosen such that h^{z-1}<P≦h^{z} (P is the number of processes/places). Each vertex p is represented as a number in base h with z digits. It has an outgoing edge to every vertex a distance+1 from it in the Manhattan distance (in modulo h arithmetic). That is, the vertex p labeled (a₁, . . . , a_{z}) has an outgoing edge to every vertex q such that for some iε1 . . . z, q=(a₁, . . . , (aᵢ+1)% h, . . . , a_{z}).

In two dimensions (z=2), a square of size h² results with all the elements in a row connected in a cycle, and all the elements in a column connected in a cycle. In such a graph the average number of hops for work to travel from one place to another is (h×z)/2. Usually P<h^{z} and P is embedded in a graph with h^{z} nodes. Care is taken to ensure that each place is connected to the next node in that dimension that represents a real, distinct place. This may mean that in a particular dimension a node has no neighbor, i.e., it has less than z lifelines. It can be shown that for every P>1 every node has at least one neighbor.

Systems and method in accordance with the present invention implement the lifeline scheme using a parallel processing program such as X10. A core implementation for binomial trees is around 150 lines of code, not counting the implementation of SHA1Rand. The full implementation, with libraries for w-adic numbers, support for geometric trees, command-line processing, timing, data-collection and comments, is about 1500 lines.

Identical code was timed on three different platforms, a small x86-Infiniband cluster (Triloka), a Blue Gene/P machine and a Power7-Infiniband cluster. On the 157 billion node binomial tree, the implementation shows an efficiency of 87% for 1024 cores on BG/P (483.2 vs 0.54 M Nodes/sec), and 86% for 1024 cores on Power7 (2371 vs 2.7 M Nodes/sec), and 94% for 128 cores on x86 (253.4 vs 2.1 M Nodes/sec). All comparisons are with sequential performance. These numbers contrast with the 80% efficiency on 1024 cores of an x86 cluster. On a larger binomial tree, of size 416b, the implementation shows an efficiency of 87% for 2048 cores of BG/P (966.11 vs 0.54 MNodes/sec). The implementation was also benchmarked on a geometric tree of size 109B. The implementation shows an efficiency of 89% (1683 vs 1.85 M Nodes/sec) on the Power7 cluster and an efficiency of 92% (357.6 vs 0.38 M Nodes/sec) on the Blue Gene/P cluster.

In X10, an async(p)S statement launches an activity at place p. This activity executes S and terminates. The invoking activity continues immediately without waiting for the newly created activity to terminate. An at(p)S statement executes statement S synchronously at place p. Therefore, the execution of the activity is suspended until S terminates. An at(p)e expression evaluates e at p and returns the result. A finish S statement executes statement S and waits until all activities created during its execution have themselves (recursively) terminated. These activities may be launched at the current place or some remote place. In the implementation illustrated herein, each place is running a single worker, and workers are not dynamically created. Therefore user code explicitly calls Runtime.probe( ) to service incoming (synchronous or asynchronous) requests. User code determines the frequency of polling. Incoming messages are processed only at specific places in user code, namely calls to Runtime.probe( ) in the user code or to remote operation invocations, i.e., the asynchronous async(p)S operation or synchronous at(p)S. At this point zero or more incoming messages (async's, at's) may be processed. Since all data-structures are touched by a single worker thread, no locks are needed to guarantee atomicity or mutual exclusion. Like Cilk, deques store unexecuted tasks. The owning process operates on the shallow end of the deque, using it as a stack, whereas responses to stealing and lifeline requests operate on the deep end of the deque. This is important even in the absence of multiple threads, i.e., contention, because it promotes cache reuse. There is a greater chance that unexecuted tasks that have just been spawned are not stolen and hence are still in cache. If no user code is running at a place, the X10 worker continues to run and will process incoming messages until a termination signal is received from place 0.

The code below uses a deque, implemented as a circular buffer. The deque supports push( ) and pop( ) operations on one end and a steal(i) operation at the other end. The parameter i specifies the number of elements to remove. The arrangement satisfies the following invariants. At any time, at most one activity runs in a given place. At any time, at most one message has been sent on an outgoing lifeline, and hence at most one message has been received on an incoming lifeline. First, an object is created at each place. This object maintains information about the state of the execution at that place, e.g. counters. This object is referenced through a place local handle, st( ). This handle is freely communicated from place to place. At any place P, the object associated with this handle at that place is obtained by simply applying st( ) to the empty argument list, that is, evaluating st( ). The object maintains the following information—various parameters associated with the tree being constructed. Of particular interest are, nu, the maximum number of tasks that will be popped for execution from the dequeue before distribution and polling, w, the maximum number of random steals made before turning to lifeline steals, z, the dimensionality of the lifeline graph, and k, the number of items to steal at a time (k=0 for “steal half”). The Boolean control variable active that is true if and only if a user-activity is running at the place. The Boolean control variable noLoot, which is used to record whether loot (number of stolen tasks) has arrived synchronously. The array lifelinesActivated contains a Boolean per place, and lifelinesActivated(p.id) is true only if this place has activated the outgoing lifeline top, and has not yet received loot in return. In principle only [z values need to be recorded. In one embodiment, the implementation keeps an array of P booleans. A stack thieves records which incoming lifelines have been activated. The size of this stack is bounded by z.

Computation is initiated from place 0. The given root node is expanded one level. This will typically cause tasks to be added to the deque. Then an async is spawned at each place, other than 0. The async is given an initial apportionment of loot. This may be empty. Finally, the current activity continues by processing its own deque, after marking itself as active. Once it has finished processing its stack, it terminates.

```
def main (st:PLH, rootNode:TreeNode) {
  finish {
    processBinomialRoot (b0, rootNode, deque);
    val lootSize = stack.size( )/Place.MAX PLACES;
    for (var pi:Int=1 ; pi<P ; ++pi) {
      val loot = deque.steal(lootSize);
      async (Place(pi))
        st( ).launch(st, true, loot, 0);
    }
    active=true;
    processDeque(st);
    active=false;
  }
}
```

When an activity is launched at a place p from places, it first resets the local Boolean flag lifelinesActivated(s) at p, enabling code running at p to establish a new lifeline back to s at a future point in time. It then checks to see if an activity is already running, i.e., if active is true. If so, it simply processes the loot and terminates. Otherwise it becomes “the” activity at this place. After processing its loot, it determines whether there are any incoming lifelines, and if so distributes work through those lifelines. Finally it processes all the elements remaining on its deque until the deque is empty, which could take a long time. It then terminates. Launch is invoked at place either by the main activity or through the distribution mechanism.

```
def launch(st:PLH, init:Boolean,
  loot:ValRail[TreeNode], depth:Int, source:Int) {
    lifelinesActivated(source) = false;
    if (active) {
      noLoot = false;
      for (r in loot) processSubtree(r);
    } else {
      active=true;
      for (r in loot) processSubtree(r);
      if (depth > 0)
        distribute(st, depth+1);
      processDeque(st);
      active=false;
    }}
def processSubtree (node:TreeNode) {
  ++nodesCounter;
  binomial (q, m, node, deque);
}
```

The deque is processed in a loop until empty. Each time around in the loop, at most nu items are processed from the deque. The network is then probed to handle incoming messages. If some thieves have registered themselves, loot is distributed. When the deque becomes empty, an attempt is made to steal from other workers. If no loot is found the activity terminates, otherwise it resumes processing the deque.

```
def processDeque(st:PLH) {
  while (true) {
    var n:Int = min(deque.size( ), nu);
    while (n > 0) {
      for ((count) in 0..n−1)
        processSubtree(deque.pop( ));
      Runtime.probe( );
      val numThieves = thieves.size( );
      if (numThieves > 0)
        distribute(st, 1, numThieves);
      n = min(deque.size( ), nu);
    }
    val loot = attemptSteal(st);
    if (null != loot)
      processLoot(loot, false);
    else {
    if (! noLoot) {
      noLoot=true;
      continue;
    }
    else
      break;
}}}
```

A command line parameter (n) controls the frequency of polling. This affects the performance of the program. Frequent polling incurs overhead and comes in the way of the worker executing real work. Infrequent polling means that steal requests from thieves are not processed quickly, thereby stalling thieves. In practice, n=511 or n=1023 gives good results for most UTS workloads.

A distribution is made to an incoming lifeline only if there is enough work. Work is popped from the deep-end of the deque. To distribute work, an async is launched at the target place. This async is governed by the single finish in main.

```
def distribute(st:PLH, depth:Int) {
  val n = thieves.size( );
  if (n > 0)
    distribute(st, 1, n);
}
def distribute(st:PLH, depth:Int, var n:Int) {
  val lootSize= deque.size( );
  if (lootSize > 2u) {
    n = Math.min(n, lootSize−2);
    val s = lootSize/(n+1);
    for ((i) in 0..n−1) {
      val thief = thieves.pop( );
      val loot = deque.steal(s);
      async (Place(thief))
        st( ).launch(st, false, loot, depth);
    }
  }
}
```

Various modifications are possible. Instead of dividing the current set of tasks evenly among all the recipients, the donor could randomly select one of the thieves and send it a portion of the loot, depending on the value of k. This would be a dual to random work-stealing, here work is “pushed” to places that have indicated earlier that they needed work. These places may no longer need work, since some other lifeline may have supplied them. Another consideration is that as the code is written it copies the items out of the deque one at a time for each target destination. An alternative would be for the activity to block off portions of the deque and trigger asynchronous DMA's to transfer the loot to the destination. This may result in better performance, particularly at high z's and in cases where the size of the deque can grow large.

To make a steal, an activity randomly guesses another place, and uses the at operation to retrieve loot from that place. It tries this at most w times, also breaking immediately if loot arrives asynchronously, for example because it is being distributed on a lifeline. If no loot is received during this phase, the activity tries its lifelines one after the other, returning as soon as loot is found. Care is taken to ensure that a request is not made of an outgoing lifeline if a request has already been made of that lifeline and no loot has been received from it so far. The difference between the stealHandler( ) invocations in the direct steal phase and in the lifeline phase is the second argument: this is set to true only in the lifeline phase.

```
def attemptSteal(st:PLH):ValRail[TreeNode] {
  if (Place.MAX PLACES == 1) return null;
  for (var i:Int=0; i < width && noLoot; i++) {
    var q :Int = 0;
    val p=here.id;
    while((q = myRandom.nextInt(Place.MAX PLACES))== p) ;
    val q = q ;
    val loot = at (Place(q)) st( ).trySteal(p,false);
    if (loot != null) return loot;
}
if (! noLoot) return null;
for (var i:Int=0;
      (i<myLifelines.length( )) && noLoot
    && 0<=myLifelines(i);
  ++i) {
  val L:Int = myLifelines(i);
  if (!lifelinesActivated(L) ) {
    lifelinesActivated(L) = true;
    val loot = at(Place(L)) st( ).trySteal(p, true);
    if (null!=loot) {
      lifelinesActivated(L) = false;
      return loot;
    }}}
  return null;
}
```

A given try at a steal is handled by examining the size of the deque. If the deque has enough tasks, then they are popped from the deque and returned. Otherwise if is LifeLine is set, the place making the try is recorded in the thieves stack, which is used during distribution.

```
def trySteal(p:Int, life:Boolean):ValRail[TreeNode] {
  val length = deque.size( );
  val numSteals = k==0u ? (length >=2u ? length/2u : 0u)
  : (k < length ? k : (k/2u < length ? k/2u : 0u));
  if (numSteals==0u) {
    if (life)
      thieves.push(p);
    return null;
  }
  return deque.steal(numSteals);
}
```

Each worker polls periodically. When a given worker receives a steal request, that worker determines the amount of loot to release, removes it logically from the deque, without copying it out, and returns a remote reference to the loot. The thief then initiates a separate DMA to retrieve the loot. This DMA request is handled purely by the network adapter without disrupting the worker. Thus the worker does not need to spend time copying the loot and avoids polluting its cache. Data is also transferred by DMA where possible.

X10 has idioms for expressing DMA transfer to remote locations. However for the trees that are considered in the present invention, the loot to be transferred is rarely more than a few hundred elements, and stealing is relatively infrequent. For such systems it is not clear that the more elaborate implementation wins. In one embodiment, DMA steals are implemented within the context of a unified implementation.

The concept of “steal half” works best for binomial trees, because the binomial tree is such that each node has the same potential to generate work. Stealing half leads to more rapid diffusion of work through the system. This is in contrast to the fixed-function geometric tree in which nodes higher in the tree have a much greater potential to generate work than nodes lower in the tree. For such systems steal-half gives poor performance and fixed-size steals are better. For example, in certain geometric trees stealing 7 items at a time works well.

In one example, results using an exemplary method in accordance with the present invention were obtained by compiling the program with the 2.0.5 version of the X10 compiler. All speedups are reported with respect to the performance of a sequential implementation of UTS. The sequential program is iterative and uses the same deque data-structure used by the parallel program to record the nodes of the tree being constructed. It does not have any parallel overheads associated with it. Specifically, it does not invoke the probe operation. However, because sequential runtimes for large trees can be very large, the size of the input on which the sequential program was run was reduced. Table 1 gives a detailed description of the trees used to test the sequential performance of UTS on our test machines.

TABLE 1

| Machine | Tree type | T | r | b | m | q | A | d | Tree size | MNodes/sec |
|---|---|---|---|---|---|---|---|---|---|---|
| Triloka | BINOMINAL | 0 | 559 | 2000 | 2 | 0.49995 | — | — | 57354859 | 2.104 |
| ANL- | BINOMINAL | 0 | 559 | 2000 | 2 | 0.499 | — | — | 2859057 | 0.54 |
| BG/P | | | | | | | | | | |
| P7HV32 | BINOMIAL | 0 | 42 | 20000 | 6 | 0.166666665 | — | — | 510009729 | 2.7 |
| P7HV32 | GEOMETRIC | 1 | 0 | 4 | — | — | 3 | 10 | 6700654 | 1.85 |
| IBM- | GEOMETRIC | 1 | 0 | 4 | — | — | 3 | 10 | 6700654 | 0.37 |
| BG/P | | | | | | | | | | |

Sequential performance of UTS on various machines for both BINOMIAL and GEOMETRIC trees was measured using smaller trees. The command-line parameters used to generate the trees for sequential benchmarking are shown in Table 1.

Three different experimental platforms were used for the empirical evaluation. The first is Triloka, which is a small cluster of 16 IBM LS-22 blades connected by a 20 Gb/sec IB network. Each node has 2 quad-core AMD 2.3 Ghz Opteron processors, 16 GB of memory and is running Red Hat Enterprise Linux 5.3. The second is Blue Gene/P. Each compute node in a Blue Gene/P system has 2 GB of memory and 4 850 MHz PowerPC 450 processors each with a dual floating point unit. The third is P7HV32, which is a 32-node Power7 cluster interconnected by Infiniband. Each compute node has 32 3.3 GHz processor cores, 128 GB of physical memory and runs SuSE Linux Enterprise Server v 11.1 for ppc64. On all platforms, X10 version 2.0.5 was used as was the C++ backend, which compiles the X10 source code to C++ files which are then compiled into an executable using a standard C++ compiler. The generated C++ code was compiled with g++ v 4.3.2 on Triloka; g++ v 4.1.2 on Blue Gene/P and g++ v 4.3.4 (Power specific version) on P7HV32.

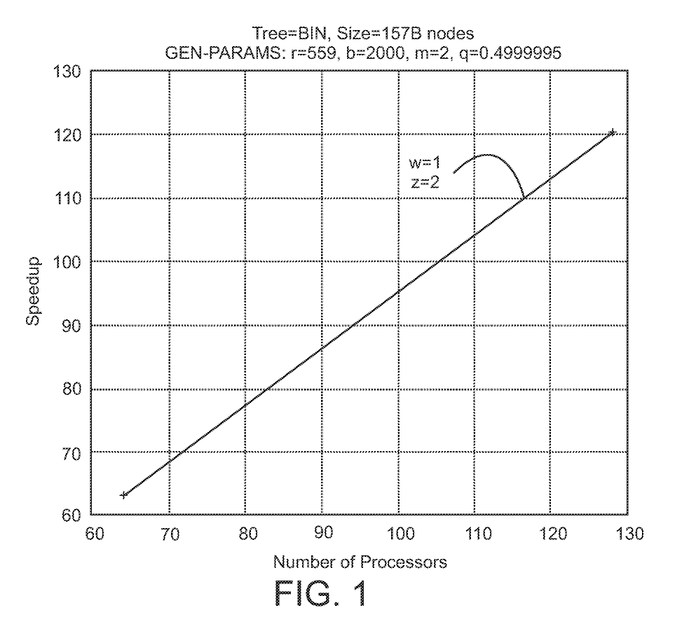

In general, the lifecycle or “lifestory” of a given run includes transitions between a plurality of states for each place or node. These states are computing, stealing, distributing, probing and idle. Referring to FIG. 1, a graph illustrates speedup versus number of processors for the small x86 Triloka cluster for a w value of 1 and a z values of 2. The implementation achieves 94% efficiency vs. sequential execution for 128 cores. Similar performance curves were obtained for other combinations of w and z for this configuration. The speedups are measured with respect to sequential performance numbers. Since problem sizes run on large machines are typically large, it is impractical to obtain sequential performance numbers by running the same program in sequential mode. Therefore, sequential numbers are computed by running the program on a smaller tree of the same basic shape. The actual parameters used to compute the sequential performance are given in Table 1.

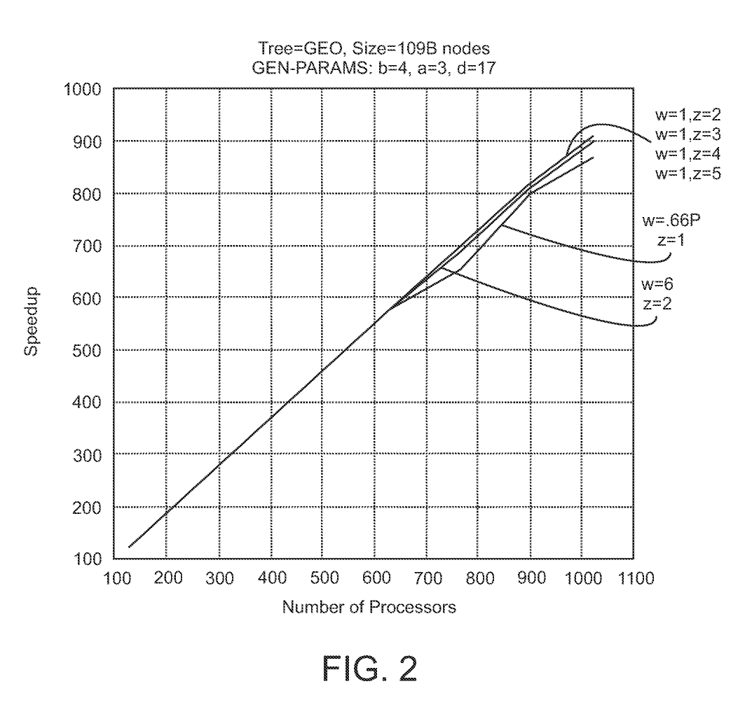

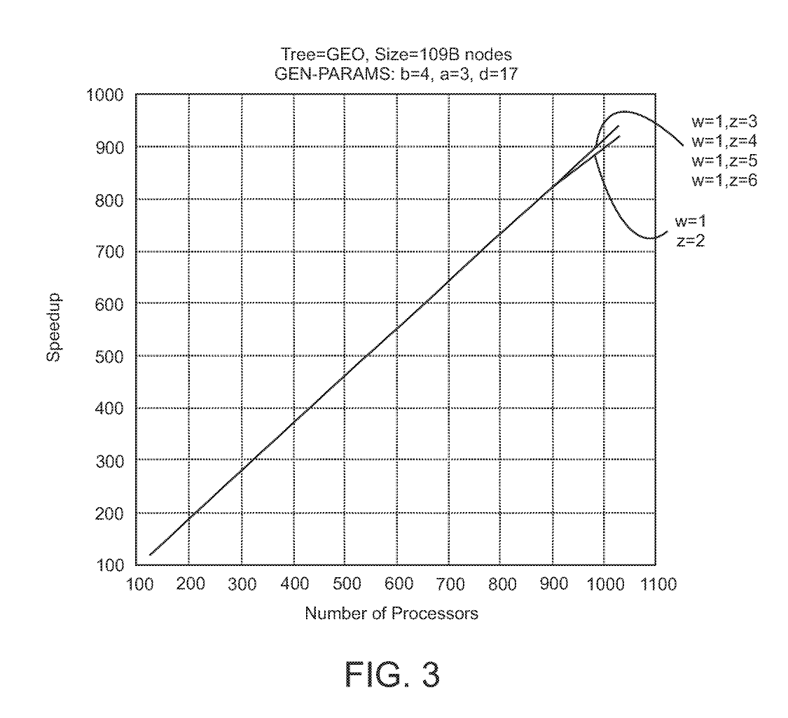

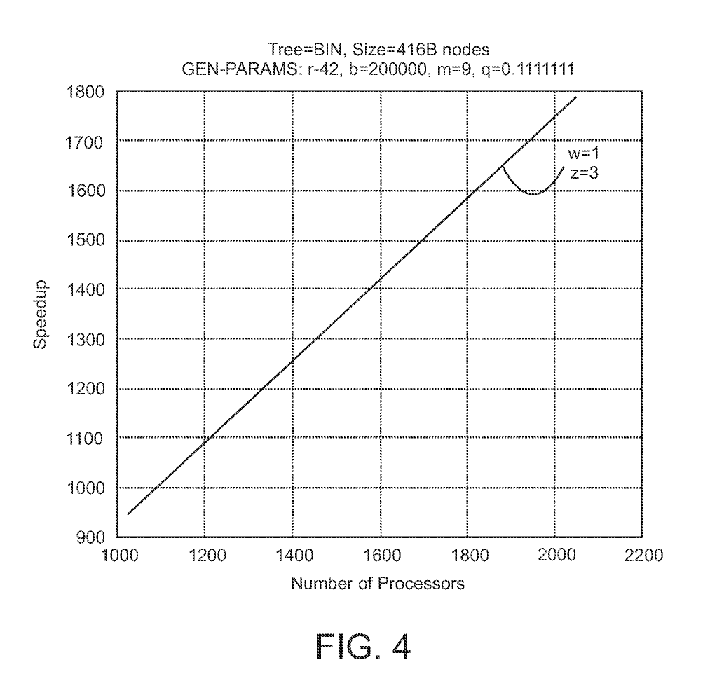

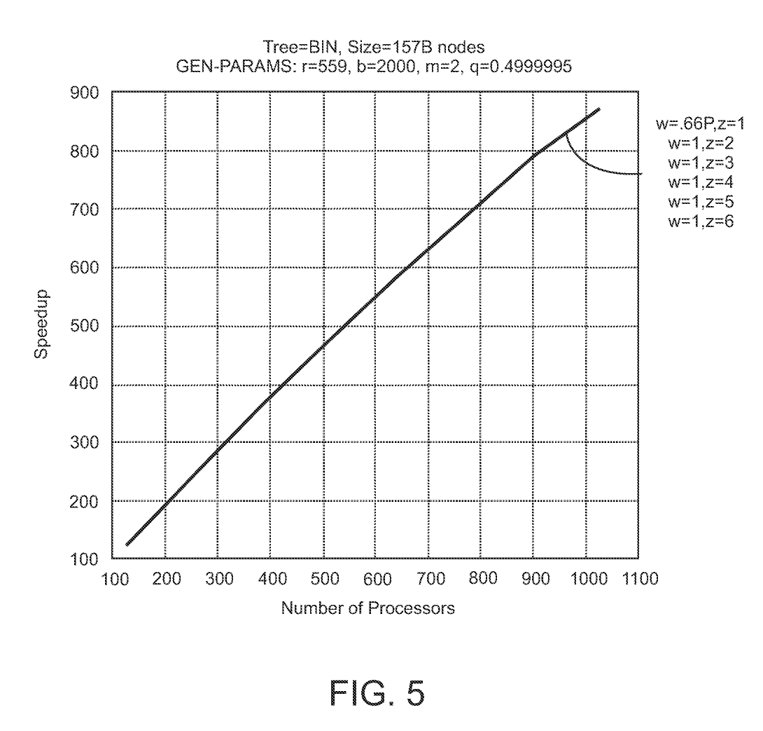

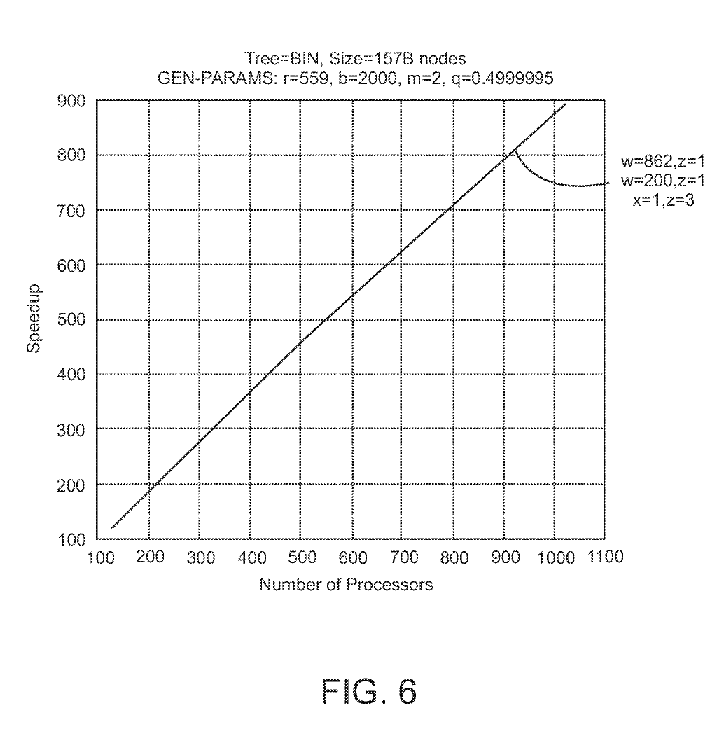

Referring to FIG. 2, a graph illustrates speedup data for multiple executions of the 157B tree for different points in the (w, z) space. Performance stays the same as w decreases dramatically, while z is increased modestly. At 1024 cores, the implementation delivers an efficiency of 87%. FIG. 3 is a graph illustrating speedup data for this tree on the P7HV32 cluster, which also delivers 87% efficiency at 1024 cores. The results for high-w, ((w,z)=(0.66×P,1)) are starting to get marginally worse than results for high-z. FIG. 4 is a graph of speedup data illustrating that the efficiency is maintained, albeit at a bigger tree size, as the core count is doubled. FIGS. 5 and 6 are graphs that show speedup for a geometric tree of 109B nodes on the Blue Gene/P and P7HV32 clusters respectively with varying values of w and z. The implementation achieves an efficiency of 92% and 89% respectively. Again, high-w results tend to be slightly worse than high-z results.

Exemplary embodiments in accordance with the present invention are implemented in a few hundred lines of X10. On the binomial tree the program achieves about 87% efficiency on an Infiniband cluster of 1024 Power7 cores, with a peak throughput of about 2.37 GNodes/sec. It achieves about 87% efficiency on a Blue Gene/P with 2048 processors, and a peak throughput of about 0.966 GNodes/s. All numbers are relative to single core sequential performance. This implementation has been refactored into a reusable global load balancing framework. Applications can use this framework to obtain global load balance with minimal code changes.

In general, systems and methods in accordance with the present invention provide the first formulation of UTS that does not involve application level global termination detection. In addition, lifeline graphs are used to reduce failed steals, and these simple lifeline graphs are preferably based on k hypercubes. The result is performance for load sharing across distributed memory systems with either superior efficiency or equivalent efficiency over a wider range than published results on UTS. In particular, the same or better performance as an unrestricted random work-stealing implementation is provided while reducing the number of attempted steals.

A requirement for efficient parallel execution of a program is that work, including computational work and other types of work, be evenly divided among the available computing resources, i.e., the program's execution is load balanced. Many applications are regular in that these applications' computations and the related data can be partitioned apriori. Regular programs can be efficiently load balanced statically. However, there are many applications that are irregular and dynamic, i.e., the computations and the data sets in these applications cannot be partitioned a priori. Irregular applications are extremely sensitive to load balancing and place unique requirements on parallel programming tools and runtimes that have not yet been satisfied. One method for efficient execution of irregular applications on distributed-memory systems utilized application-level dynamic load balancing.

Early research on dynamic load balancing for shared-memory systems was carried out in the Mul-T Scheme project. Load balancing was achieved through lazy task creation where threads would steal work from one another when they ran out of work. Cilk, an extension to the C language, was the first system to provide efficient load balancing for a wide variety of irregular applications. Load balancing in Cilk applications is achieved by a scheduler that follows the depth-first work, breadth-first steal principle. Cilk's scheduling policy, in which each thread of execution maintains its own set of tasks, and steals from other threads on a need-by basis, is often dubbed work-stealing. Currently, there are many solutions for task parallelism that offer work-stealing schedulers. The other variants of Cilk-like work-stealing in parallel computing frameworks include X10's breadth-first work scheduling policy and a hybrid model for work stealing. It has been shown that different work-stealing strategies are required for different irregular applications, and a library framework can be used to allow easy customization of load balancing policies on shared memory. Work-stealing, by virtue of taking a distributed approach to load balancing processors, is stable.

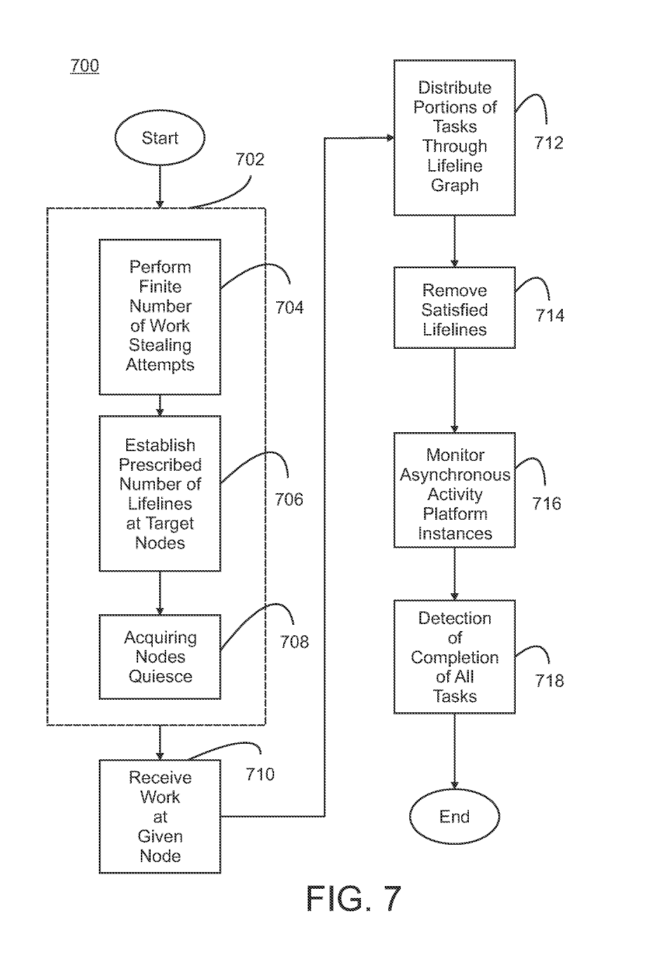

Referring to FIG. 7, exemplary embodiments in accordance with the present invention are directed to a method for load balancing in a distributed memory system 700. A lifeline graph is established 702 within a distributed memory system. This distributed memory system comprises a plurality of processors or computer systems. Each processor includes a memory and processing unit and is communication with the other processors across one or more local or wide area networks. Each processor uses its locally stored data to process tasks and communicates with other processors to share tasks or data as required. The lifeline graph is preferably a fully connected directed graph and includes a plurality of vertices, each having a bounded out degree. Each vertex represented a node within the distributed memory system configured to execute tasks. These nodes can be one of the processors within the distributed memory system or physical or virtual cores within a given processor. In general, a given node is any physical or virtual device capable of processing tasks. The lifeline graph also includes a plurality of edges among the vertices or nodes. Each edge extends between a given pair of vertices and extends out from a first vertex and in to a second vertex. Therefore, each vertex has associated incoming edges for receiving tasks from other vertices, i.e., nodes, and outgoing edges for transferring tasks to other vertices, i.e., nodes. Preferably, the plurality of edges is arranged among the vertices such that a path exists through the lifeline graph from any given vertex to every other vertex. In one embodiment, the lifeline graph is established as a cyclic hypercube graph.

Nodes that are looking for work are the acquiring nodes, and nodes that have work are target nodes. In order to establish the lifeline graph, a pre-determined finite number of attempts are made from one or more of a plurality of acquiring nodes within the distributed memory system to obtain tasks from a set of randomly selected target nodes 704 also located within the distributed memory system. If these attempts to acquire tasks are node successful, the edges are established 706 from each acquiring node to one or more target nodes in its set of randomly selected target nodes when all attempts to obtain tasks are unsuccessful. The acquiring nodes then stop making attempts to acquire tasks and quiesce 708. In one embodiment, an identification of a given acquiring node is recorded at a given target node in combination with an established edge at a given target node when that given target node does not contain tasks capable of being obtained by the given acquiring node. The established edge and the given acquiring node identification is a lifeline for the acquiring node and an incoming edge at the given target node. In one embodiment, the number of edges or lifelines, i.e., the outdegree of any given acquiring node, from each acquiring node is limited to a pre-determined bounded number of target nodes. In an embodiment where a parallel processing program is running on the distributed memory system, e.g., X10, an asynchronous activity platform is instantiated at each acquiring node to support performing the pre-determined finite number of attempts to obtain tasks from each target node as well as establishing vertices from each acquiring node to one or more target nodes. This asynchronous activity platform instance is terminated at each acquiring node following establishment of the edges from that acquiring node to the target nodes.

With the lifeline graph established, work is received 710 at one or more given nodes within the lifeline graph. This work includes a plurality of tasks, and these tasks can be further divided into sub-tasks. A portion of the plurality of tasks is distributed 712 from the node having the work along each incoming edge associated with that node to each receiving node for which the incoming edges on the node with the work are outgoing edges. Therefore, the tasks are distributed up the lifelines through the lifeline graph to the previous acquiring nodes for which the node having the work was a target node. As the receiving nodes may also have been targets nodes, distribution of tasks continues through the lifeline graph. In one embodiment, a subset of any given portion of the plurality of tasks received at any receiving node is further distributed along each incoming node associated with that receiving node to a subsequent receiving node for which that receiving node incoming edge comprises an outgoing edge. This distribution scheme continues using additional subsets of tasks until all tasks have been distributed through the vertices in the lifeline graph or until all acquiring nodes have been satisfied. In one embodiment, each incoming edge associated with the given node from the lifeline graph is removed 714 following distribution of the portion of the plurality of tasks to the receiving node. Therefore, satisfied lifelines are removed from the lifeline graph.

When the distributed memory system includes a parallel processing program, a place shifting operation from the parallel processing program moves the portion of the plurality of tasks along each incoming edge, i.e., between nodes along lifelines. In addition, asynchronous activity platform instances from the parallel processing program are used at each receiving node to support execution of tasks distributed to that receiving node. As these nodes quiesce following failed attempts to acquire tasks, new instances of the asynchronous activity platform are established. Therefore, the existence of instances of the asynchronous activity platform indicates that nodes are either looking for tasks or executing tasks. The absence of any such instances indicates that all tasks have been completed and that all nodes have quiesced as there are no tasks to acquire from targets.

Exemplary embodiments in accordance with the present invention utilize this understanding regarding asynchronous activity platform instances to monitor the status of task completion within the distributed memory system. In one embodiment, asynchronous activity platform instances are monitored 716 to detect their termination. A single top-level termination monitoring utility from the parallel processing program is used for this monitoring of all instances in all nodes within the distributed memory system. Completion of all tasks within the distributed memory system is then detected 718 through termination of all asynchronous activity platform instances.

In one embodiment of the method for load balancing in a distributed memory system using the parallel processing program, an asynchronous activity platform from the parallel processing program running on the distributed memory system is instantiated at each one of the plurality of task executing nodes within the distributed memory system. This instance of the asynchronous activity platform at each one of a plurality of acquiring nodes supports performing a pre-determined finite number of attempts to obtain tasks for each acquiring node from one or more randomly selected target nodes within the distributed memory system. In addition, edges as described above are established from each acquiring node to one or more target nodes in its set of randomly selected target nodes when all attempts to obtain tasks are unsuccessful. When work comprising a plurality of tasks is received at given node, the a place shifting operation from the parallel processing program distributes a portion of the plurality of tasks along each incoming edge associated with that node to a receiving acquiring node for which that incoming edge comprises an outgoing edge. In addition, instances of the asynchronous activity platform at each receiving acquiring node support execution of the tasks distributed to that receiving acquiring node. The distributed memory system is monitored for termination of all asynchronous activity platform instances using a single top-level termination monitoring utility from the parallel processing program. Termination of all asynchronous activity platform instances indicates distribution and completion of all tasks within the distributed memory system.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Methods and systems in accordance with exemplary embodiments of the present invention can take the form of an entirely hardware embodiment, an entirely software embodiment or an embodiment containing both hardware and software elements. In a preferred embodiment, the invention is implemented in software, which includes but is not limited to firmware, resident software and microcode. In addition, exemplary methods and systems can take the form of a computer program product accessible from a computer-usable or computer-readable medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which provide temporary storage of at least some program code in order to reduce the number of times code must be retrieved from bulk storage during execution. Input/output or I/O devices, including but not limited to keyboards, displays and pointing devices, can be coupled to the system either directly or through intervening I/O controllers. Exemplary embodiments of the methods and systems in accordance with the present invention also include network adapters coupled to the system to enable the data processing system to become coupled to other data processing systems or remote printers or storage devices through intervening private or public networks. Suitable currently available types of network adapters include, but are not limited to, modems, cable modems, DSL modems, Ethernet cards and combinations thereof.

In one embodiment, the present invention is directed to a machine-readable or computer-readable medium containing a machine-executable or computer-executable code that when read by a machine or computer causes the machine or computer to perform a method for load balancing in a distributed memory system in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A method for load balancing in a distributed memory system, the method comprising:
establishing a lifeline graph within the distributed memory system, the lifeline graph comprising:
a plurality of vertices, each vertex comprising a node within the distributed memory system configured to execute tasks; and
a plurality of edges, each edge extending between a given pair of vertices, each vertex having associated incoming edges for receiving tasks from other vertices and outgoing edges for transferring tasks to other vertices and the plurality of edges arranged among the vertices such that a path exists through the lifeline graph from any given vertex to every other vertex;
receiving work at given node within the lifeline graph, the work comprising a plurality of tasks; and
distributing a portion of the plurality of tasks along each incoming edge associated with that node to a receiving node for which that incoming edge comprises an outgoing edge.

2. The method of claim 1, wherein the step of establishing the lifeline graph further comprises establishing a cyclic hypercube lifeline graph.

3. The method of claim 1, wherein the method further comprises distributing a subset of any given portion of the plurality of tasks received at any receiving node along each incoming node associated with that receiving node to a subsequent receiving node for which that receiving node incoming edge comprises an outgoing edge.

4. The method of claim 1, wherein the step of distributing the subset further comprises continuing distribution of subsets of tasks between vertices until all tasks have been distributed through the vertices in the lifeline graph.

5. The method of claim 1, wherein the step of distributing the subset further comprises using a place shifting operation from a parallel processing program running on the distributed memory system to move the portion of the plurality of tasks along each incoming edge.

6. The method of claim 5, wherein the step of distributing the subset further comprises instantiating an asynchronous activity platform from the parallel processing program at each receiving node to support execution of tasks distributed to that receiving node.

7. The method of 6, wherein the method further comprises monitoring for termination of all asynchronous activity platform instances using a single top-level termination monitoring utility from the parallel processing program, wherein termination of all asynchronous activity platform instances indicates completion of all tasks within the distributed memory system.

8. The method of claim 1, wherein the method further comprises removing each incoming edge associated with the given node from the lifeline graph following distribution of the portion of the plurality of tasks to the receiving node.

9. The method of claim 1, wherein the step of establishing the lifeline graph within the distributed memory system further comprises:
performing a pre-determined finite number of attempts to obtain tasks at each one of a plurality of acquiring nodes from a set of randomly selected target nodes within the distributed memory system; and
establishing edges from each acquiring node to one or more target nodes in its set of randomly selected target nodes when all attempts to obtain tasks are unsuccessful.

10. The method of claim 9, wherein the step of establishing edges further comprises recording an identification of a given acquiring node in combination with an established edge at a given target node when that given target node does not contain tasks capable of being obtained by the given acquiring node, the established edge and the given acquiring node identification comprising an incoming edge at the given target node.

11. The method of claim 9, wherein the step of establishing edges from each acquiring node further comprises establishing edges from each acquiring node to a pre-determined bounded number of target nodes.

12. The method of claim 9, wherein the method further comprises instantiating an asynchronous activity platform from a parallel processing program running on the distributed memory system at each acquiring node to support performing the pre-determined finite number of attempts to obtain tasks from each target node and establishing vertices from each acquiring node to one or more target nodes.

13. The method of claim 12, wherein the method further comprises terminating the asynchronous activity platform instance at each acquiring node following establishment of the edges from that acquiring node to the target nodes.

14. A method for load balancing in a distributed memory system, the method comprising:
instantiating an asynchronous activity platform from a parallel processing program running on the distributed memory system at each one of a plurality of nodes within the distributed memory system, each node configured to execute tasks;
using an instance of the asynchronous activity platform at each one of a plurality of acquiring nodes to support performing a pre-determined finite number of attempts to obtain tasks for each acquiring node from one or more randomly selected target nodes;
establishing edges from each acquiring node to one or more target nodes in its set of randomly selected target nodes when all attempts to obtain tasks are unsuccessful, the edges comprising incoming edges at the acquiring nodes for receiving tasks from the target nodes and outgoing edges at the target nodes for transferring tasks to the acquiring nodes;
receiving work at given node, the work comprising a plurality of tasks;
using a place shifting operation from the parallel processing program to distribute a portion of the plurality of tasks along each incoming edge associated with that node to a receiving acquiring node for which that incoming edge comprises an outgoing edge;
using instances of the asynchronous activity platform at each receiving acquiring node to support execution tasks distributed to that receiving acquiring node; and monitoring for termination of all asynchronous activity platform instances using a single top-level termination monitoring utility from the parallel processing program, wherein termination of all asynchronous activity platform instances indicates distribution and completion of all tasks within the distributed memory system.

15. A computer-readable storage medium containing a computer-readable code that when read by a computer causes the computer to perform a method for load balancing in a distributed memory system, the method comprising:
establishing a lifeline graph within the distributed memory system, the lifeline graph comprising:
a plurality of vertices, each vertex comprising a node within the distributed memory system configured to execute tasks; and
a plurality of edges, each edge extending between a given pair of vertices, each vertex having associated incoming edges for receiving tasks from other vertices and outgoing edges for transferring tasks to other vertices and the plurality of edges arranged among the vertices such that a path exists through the lifeline graph from any given vertex to every other vertex;
receiving work at given node within the lifeline graph, the work comprising a plurality of tasks; and
distributing a portion of the plurality of tasks along each incoming edge associated with that node to a receiving node for which that incoming edge comprises an outgoing edge.

16. The computer-readable medium of claim 15, wherein the step of establishing the lifeline graph further comprises establishing a cyclic hypercube lifeline graph.

17. The computer-readable medium of claim 15, wherein:
the step of distributing the subset further comprises instantiating an asynchronous activity platform from a parallel processing program running on the distributed memory system at each receiving node to support execution of tasks distributed to that receiving node; and
the method further comprises monitoring for termination of all asynchronous activity platform instances using a single top-level termination monitoring utility from the parallel processing program, wherein termination of all asynchronous activity platform instances indicates completion of all tasks within the distributed memory system.

18. The computer-readable medium of claim 15, wherein the method further comprises removing each incoming edge associated with the given node from the lifeline graph following distribution of the portion of the plurality of tasks to the receiving node.

19. The computer-readable medium of claim 15, wherein the step of establishing the lifeline graph within the distributed memory system further comprises:
performing a pre-determined finite number of attempts to obtain tasks at each one of a plurality of acquiring nodes from a set of randomly selected target nodes within the distributed memory system; and
establishing edges from each acquiring node to one or more target nodes in its set of randomly selected target nodes when all attempts to obtain tasks are unsuccessful by recording an identification of a given acquiring node in combination with an established edge at a given target node when that given target node does not contain tasks capable of being obtained by the given acquiring node, the established edge and the given acquiring node identification comprising an incoming edge at the given target node.

20. The computer-readable medium of claim 19, wherein the method further comprises:
instantiating an asynchronous activity platform from a parallel processing program running on the distributed memory system at each acquiring node to support performing the pre-determined finite number of attempts to obtain tasks from each target node and establishing vertices from each acquiring node to one or more target nodes; and
terminating the asynchronous activity platform instance at each acquiring node following establishment of the edges from that acquiring node to the target nodes.
